(19) United States
(12) Patent Application Publication
(10) Pub. No.: US 2005/0102606 A1
(43) Pub. Date: May 12, 2005

(54) Modal synchronization control method and multimodal interface system

(75) Inventors: Kazuo Sasaki, Kawasaki (JP); Tatsuro Matsumoto, Kawasaki (JP); Ai Yano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/834,133

(22) Filed: Apr. 29, 2004

(30) Foreign Application Priority Data
Nov. 11, 2003 (JP) 2003-380980

(51) Int. Cl. G06F 17/00

(52) U.S. Cl. 715/500.1

(57) ABSTRACT

The invention provides a modal synchronization control method with which a plurality of browsers for modals are synchronized and multimodal services are enabled with hardly any changes to an existing web application. The modal synchronization control method includes a step of preparing, in advance, selection definition information that is stored in association with a content creation file for each of the modal types to be applied, in accordance with a combination of a plurality of modals to be synchronized; a step of selecting for each modal a content creation file to be applied, from combinations of modals of the browser and another browser to be synchronized, in response to a processing request from one of the browsers; and a step of outputting content, which has been created by applying the selected content creation file, to the browser that has originated the processing request, and outputting content, which has been created by applying the corresponding content creation file, to the other browser that is to be synchronized with the browser.

### FIELD OF THE INVENTION

The present invention relates to methods for synchronizing a plurality of user interfaces, a system implementing these methods, and a program of the same.

### BACKGROUND OF THE INVENTION

As the Internet gains in popularity and web technology advances, users have come to be able to obtain a variety of information on the internet from www (world wide web) servers, and browse that information using web browsers. Content obtained from www servers is expressed in a markup language called HTML (Hyper Text Markup Language), and web browsers interpret this information and display it on a screen.

Such web systems do not merely obtain static content on servers and display it on a screen, but have developed into web applications that process information by accessing databases or the like on the server side, in accordance with the input data from the web browser and create content dynamically based on the result of that process. This has enabled users to make ready use of various kinds of internet services, such as online shopping services or the like, from their web browsers.

On the other hand, the content markup language VoiceXML has been proposed to enable use of such web technology through telephones or the like. In VoiceXML systems, a VoiceXML browser is arranged between a telephone and a www server, the VoiceXML browser interprets the VoiceXML, thus performing a dialogue with the user, and new VoiceXML is requested from the www server as necessary in accordance with the result of voice recognition of the user's voice.

Thus, an environment has been created in which various kinds of internet services can be utilized through user interfaces such as GUI modals of web browsers or the like and voice modals for voice or the like, but when utilizing several modals that enhance one another's convenience, such as by combining the convenience of voice input with the browsability of GUIs, then there is the problem that the content provider has to implement a framework for synchronizing the browsers for each of the modals, and the burden on the developer increases.

On the other hand, as a framework for synchronizing the browsers for a plurality of modals, a synchronization method and system for a plurality of user interfaces as disclosed for example in JP 2003-15044A have been proposed. In this invention, if statically present HTML and VoiceXML are displayed by each of the browsers, then the correspondence between the respective URLs (uniform resource locators) of the HTML content and the VoiceXML content is defined in a synchronization server, and when a URL is requested by one browser, then a synchronization is performed by notifying the synchronized browser of the URL for another modal corresponding to that URL, and obtaining content corresponding to that URL from the synchronized browser. Moreover, in the case of servers creating content dynamically like web applications, when a submission is made from one browser, then content can be synchronized by letting also the corresponding browser make a submission at the same time, and letting a program such as a CGI, which is present for each modal, perform the same process for each modal, so as to create the content for each modal separately from the same processing result.

The invention disclosed in JP 2003-15044A is unproblematic when the content is synchronized for each of the statically present modals, but problems occur when applied to web applications in which content is dynamically created according to processing results on the server side.

For example, if a multimodal service is offered for the ordering system of an online shop or the like, then the order data is handed over to the ordering system, a CGI program creating content based on a processing result is arranged for each modal, and when an order is placed from one browser, an order placement is also caused on the other synchronized modal, thereby achieving synchronization.

However, since the same processing order is performed simultaneously by two browsers, there is the problem that the ordering system processes the same order multiple times. As a method for solving this problem, it is conceivable that only one CGI places the order with the ordering system, but since also the CGI that does not place the order needs to create content in accordance with the processing result, it has to receive the processing result from the CGI that has actually placed the order. Moreover, processing has to be implemented that turns the order processing function of the CGI on for ordinary single modal use, and turns the CGI function off when multiple modals are used.

Thus, with this approach of performing the same order placement with multiple browsers, there are the problems that the synchronized processing function to be implemented by the developer of the web application is complicated, and the burden on the developer is large.

It is thus an object of the present invention to solve the above-described problems, and to present a modal synchronization control method with which a plurality of browsers for modals can be synchronized and which allows easy enabling of multimodal services with hardly any changes to an existing web application, for browsers that interpret content for a specified modal so as to interact with a user, and an information processing system performing data processing in response to a request from any of the browsers, creating content based on a processing result, and outputting the content to the browsers.

### SUMMARY OF THE INVENTION

In accordance with the present invention, a modal synchronization control method for a multimodal interface system comprising, for each modal, a browser that interprets content for a specified modal so as to interact with a user, performing data processing in response to a request from any of the browsers, creating content based on a processing result, and outputting the content to the browsers; includes a step of preparing, in advance, selection definition information that is stored in association with a content creation file for each of the modal types to be applied, in accordance with a combination of a plurality of modals to be synchronized; a step of looking up the selection definition information in response to a processing request from any of the browsers, and selecting for each modal a content creation file to be applied, from combinations of modals of the browser and another browser to be synchronized; and a step of outputting content, which has been created by applying the selected content creation file, to the browser that has originated the processing request, and outputting content, which has been created by applying the corresponding content creation file of the selected content creation files, to the other browser that is to be synchronized with the browser.

It is preferable that the modal synchronization control method further comprises a step of sending a content acquisition notification to the other browser to be synchronized, and a step of outputting content in response to an acquisition request from the other browser to be synchronized.

In accordance with the present invention, in a program for executing on a computer a modal synchronization control method for a multimodal interface system comprising, for each modal, a browser that interprets content for a specified modal so as to interact with a user, performing data processing in response to a request from any of the browsers, creating content based on a processing result, and outputting the content to the browsers; the method comprises a step of looking up, in response to a processing request from any of the browsers, the selection definition information stored in association with a content creation file for each of the modal types to be applied, in accordance with a combination of a plurality of modals to be synchronized and selecting for each modal a content creation file to be applied, from combinations of modals of the browser and another browser to be synchronized; and a step of outputting content, which has been created by applying the selected content creation file, to the browser that has originated the processing request, and outputting content, which has been created by applying the corresponding content creation file of the selected content creation files, to the other browser that is to be synchronized with the browser.

In accordance with the present invention, a multimodal interface system comprises: for each modal, a browser that interprets content for a specified modal so as to interact with a user, the multimodal interface system performing data processing in response to a processing request from any of the browsers, creating content based on a processing result, and outputting the content to the browsers; a selection processing portion that looks up, in response to a processing request from any of the browsers, the selection definition information stored in association with a content creation file for each of the modal types to be applied, in accordance with a combination of a plurality of modals to be synchronized, and selects for each modal a content creation file to be applied, from combinations of modals of the browser and another browser to be synchronized; and a content output portion that outputs content, which has been created by applying the selected content creation file, to the browser that has originated the processing request, and outputs content, which has been created by applying the corresponding content creation file of the selected content creation files, to the other browser that is to be synchronized with the browser.

It is preferable that the multimodal interface system further comprises a modal managing portion, which manages combinations of a plurality of modals to be synchronized.

It is preferable that the modal managing portion receives a processing request from one of the browsers and sends content created by the content output portion to the browser that has originated the processing request.

A multimodal interface system according to another aspect of the present invention comprises for each modal, a browser that interprets content for a specified modal so as to interact with a user, the multimodal interface system performing data processing in response to a request from any of the browsers, creating content based on a processing result, and outputting the content to the browsers; a modal managing portion that manages combinations of a plurality of modals to be synchronized, and exchanges information with each of the modals; a selection processing portion that looks up, in response to a processing request from a browser, the selection definition information stored in association with a content creation file for each of the modal types to be applied, in accordance with a combination of a plurality of modals to be synchronized, selects for each modal a content creation file to be applied, from combinations of a browser and another browser to be synchronized, creates content for the corresponding modal from the content creation file of each modal, outputs content created with the content creation files to the browser that has originated the processing request, and notifies the other browser to be synchronized of acquisition request information for acquiring content created with the content creation files via the modal managing portion; and a content managing portion that, in response to acquisition request information that has been sent from the other browser to be synchronized, outputs content corresponding to that acquisition request information to that browser.

It is preferable that the content managing portion further has a function of deleting created content after outputting content corresponding to an acquisition request from the other browser to be synchronized to the browser that has originated the processing request.

A multimodal interface system according to yet another aspect of the present invention comprises, for each modal, a browser that interprets content for a specified modal so as to interact with a user, the multimodal interface system performing data processing in response to a processing request from any of the browsers, creating content based on a processing result, and outputting the content to the browsers; a modal managing portion that manages combinations of a plurality of modals to be synchronized, and exchanges information with each of the modals; a selection processing portion that looks up, in response to a processing request from a browser, the selection definition information stored in association with a content creation file for each of the modal types to be applied, in accordance with a combination of a plurality of modals to be synchronized, selects for each modal a content creation file to be applied, from combinations of a browser and another browser to be synchronized, outputs content created with a content creation file for the browser that has originated the processing request, stores information identifying the content creation file selected for the other browser to be synchronized in association with information related to a processing result of a process executed in response to a processing request from the browser, and notifies the other browsers to be synchronized of acquisition request information for acquiring content via the modal managing portion; and a content managing portion that, in response to acquisition request information that has been sent from the other browser to be synchronized, creates content from a content creation file corresponding to that acquisition request information and information relating to the processing result, and outputs the created content to that browser.

With the present invention, it becomes easy to adapt an existing single modal web application for multimodal use by simply expressing a content creation file for each modal type as well as selection definition information for content creation files defining a combination of modal types to be synchronized and a combination of content creation files to be applied.

### BRIEF DESCRIPTION OF THE DRAWINGS

FIG. 1 is a diagram of a web application for single modal use.

FIG. 2 is a diagram of a multimodal interface system according to a first embodiment.

FIG. 3 is a flowchart showing the operation of a modal managing portion.

FIG. 4 is a diagram illustrating a modal management table.

FIG. 5A is a diagram illustrating an initial screen for HTML browsers.

FIG. 5B is a diagram illustrating an initial dialogue for VXML browsers.

FIG. 6 is a flowchart showing the operation of a modal managing portion.

FIG. 7 is a diagram illustrating processing result data.

FIG. 8 is a diagram illustrating selection definition information for a content creation file.

FIG. 9 is a diagram illustrating an HTML content creation file.

FIG. 10 is a diagram illustrating a VXML content creation file.

FIG. 11 is a flowchart showing the operation of a content managing portion.

FIG. 12A is a diagram illustrating content for HTML browsers.

FIG. 12B is a diagram illustrating content for VXML browsers.

FIG. 13 is a diagram showing the configuration of a second embodiment.

FIG. 14 is a flowchart showing the operation of a selection processing portion.

FIG. 15 is a diagram illustrating an internal table created by the selection processing portion.

FIG. 16 is a diagram illustrating processing result data.

FIG. 17 is a flowchart showing the operation of a content managing portion.

### DESCRIPTION OF THE PREFERRED EMBODIMENTS

General Overview

Ordinarily, for the development of web applications, it is customary to divide the various functions in an application into components in accordance with the MVC (Model, View, Controller) paradigm, in order to reduce the burden on the developer. In MVC, the Model performs various kinds of logic processing and data management, such as searches in a database, and the View realizes the functions for creating content based on the processing results of the Model. The Controller determines the Model and the View of the called object in accordance with the data entered with the browser and its internal state, and delivers the processing results of the Model to the View. Thus, with the MVC model, by making a division into components performing the actual processing (Controller and Model) and a component creating the content in accordance with the processing result (View), it becomes easy to change the screen design without changing the processing logic, by changing only the View portion. The present invention presents a way for easily implementing multiple modals in an existing application by taking advantage of the characteristics of web applications that are split in this manner into a processing logic portion and a screen creation portion.

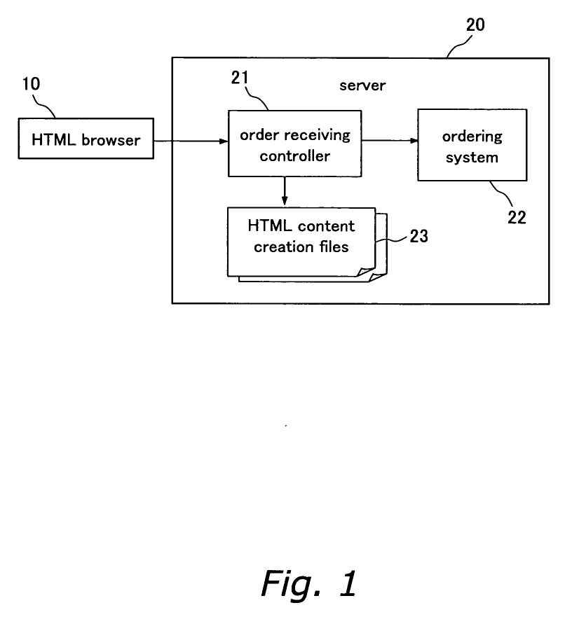

FIG. 1 is a diagram showing a web application for online shopping using an ordinary single modal. A server 20 includes an order receiving controller (corresponding to the Controller of the MVC) 21, an ordering system (corresponding to the Model) 22 and HTML content creation files (corresponding to the View) 23. The controller 21 receives input data from an HTML browser (web browser) 10. The ordering system 22 performs the actual order processing in response to requests from the order receiving controller 21. The HTML content creation files 23 create HTML content based on the processing result of the ordering system 22. For the content creation files, JSP (Java Server Pages) or the like may be used in case of a Java system. Referring to the accompanying drawings, the following is an explanation of embodiments of a modal synchronization control method and a multimodal interface system for easily making such a web application multimodal.

### First Embodiment

This embodiment is an example of a case where the present invention is applied to an ordering system that receives and processes orders for a product.

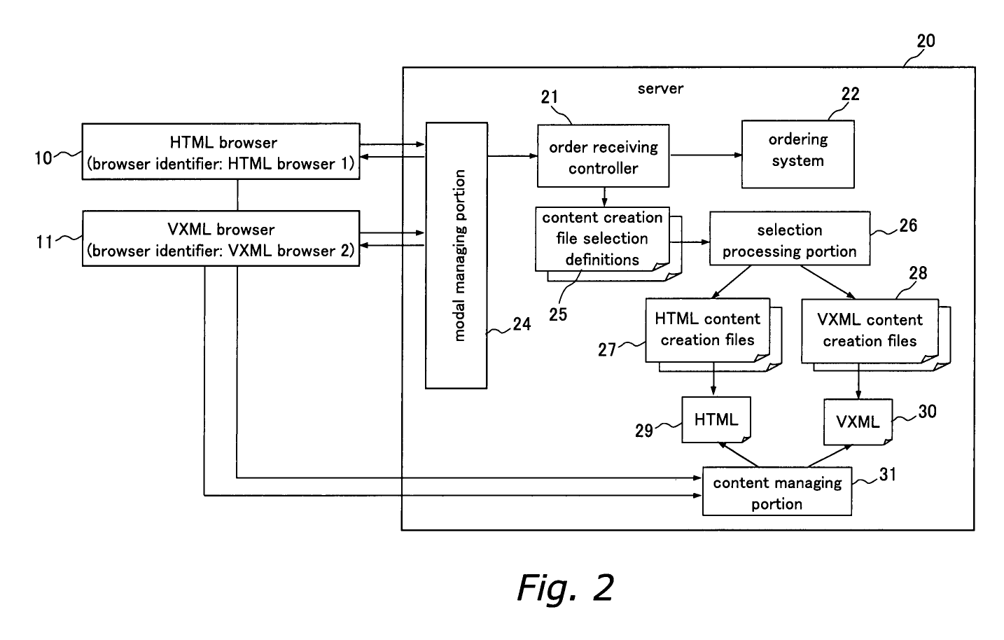

FIG. 2 shows the overall configuration of a multimodal interface system in accordance with a first embodiment of the present invention.

Here, the server 20 includes a modal managing portion 24, an order receiving controller 21, an ordering system 22, a selection processing portion 26, and a content managing portion 31. The modal managing portion 24 manages information relating to currently synchronized modals and browsers. The order receiving controller 21 receives input data from browsers via the modal managing portion 24. The ordering system 22 performs the actual order processing in response to requests from the order receiving controller 21. The selection processing portion 26 selects a content creation file based on selection definition files 25 for content creation files. The content managing portion 31 outputs content in response to synchronized content acquisition requests from the browsers.

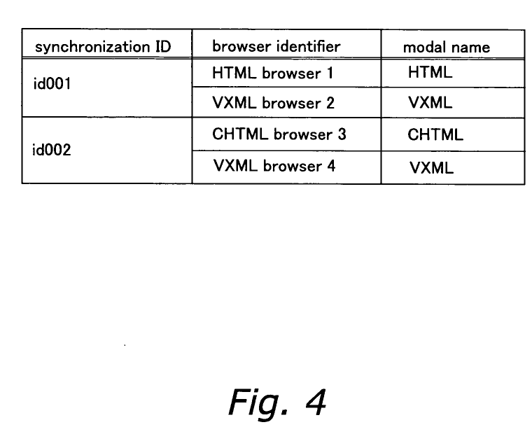

If such cases as when the synchronized modals are for an HTML browser 10 and a VXML browser 11, then the modal managing portion 24 ensures that these two browsers are synchronized. FIG. 4 shows an example of the managing data managed by the modal managing portion 24. As shown in FIG. 4, the data is stored in a table with the items synchronization ID, browser identifier and modal name, such that the modals with the same synchronization ID are synchronized and each modal is associated with one of the browsers.

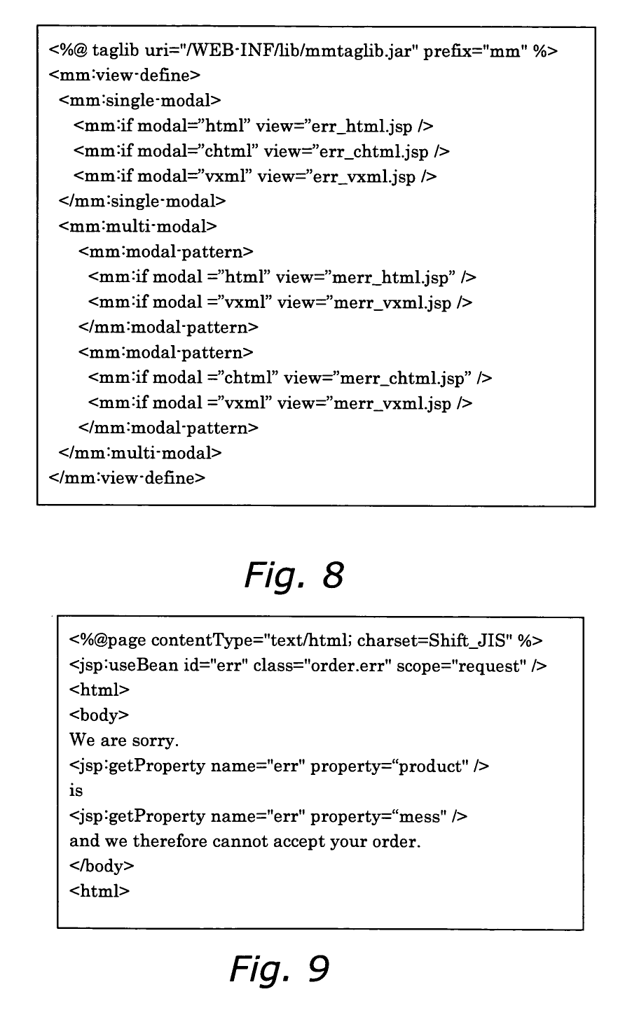

The order receiving controller 21 sends a processing request to the ordering system 22 in response to a request from the requesting browser, and transfers the processing result to the appropriate selection definition file 25, in response to the processing result of the ordering system 22. FIG. 8 shows an example of a selection definition file 25 for content creation files. The selection definition files 25 for content creation files according to the present embodiment are prepared for every processing result that may occur in the ordering system 22. The selection definition file 25 shown in FIG. 8 is an example of the case that the ordered product has caused an error in the ordering system 22, and is set up in advance for the case where the ordered product is accepted as ordered and for each of the processing results that may occur otherwise. In this example, content creation files corresponding to the various modals are defined within the tag <mm:multi-modal> for the case that the modal combination is HTML and VXML, and for the case that it is CHTML and VXML, and the corresponding content creation file names are stated for example as JSP (Java Server Page) names.

The selection definition files 25 are executed by transferring the processing result from the order receiving controller 21, and, simultaneously to this execution, a selection process is performed by reading the selection definition file with the selection processing portion 26. In the selection processing example shown in FIG. 8, the library “mmtaglib.jar” at the start of the definition is launched in conjunction with the execution of the selection definition file 25.

Based on the definitions in the selection definition file 25 and the combination with the modals of the other browser synchronized with the browser that has originated the request, the selection processing portion 26 extracts a content creation file name for each of the modals to be applied, and transfers the processing result from the order receiving controller 21 to each of the extracted content creation files.

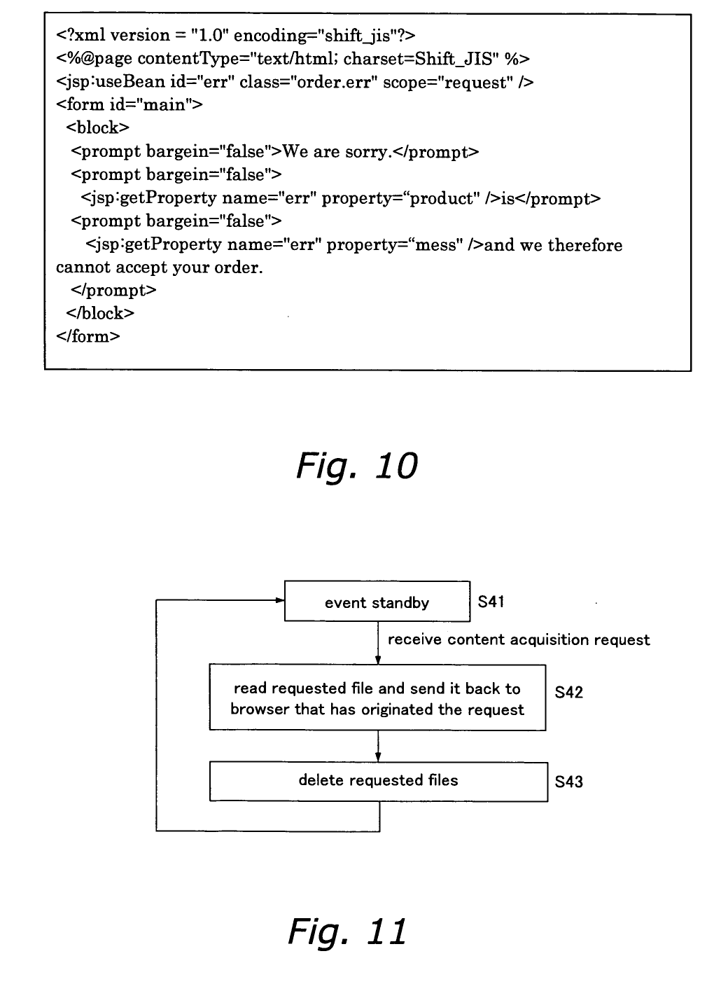

Here, in response to requests from the HTML browser 10 or the VXML browser 11, the selection processing portion 26 extracts a corresponding HTML content creation file 27 and a corresponding VXML content creation file from the selection definition file 25 for content creation files, and transfers the processing result of the ordering system to each of the content creation files to create HTML content 29 and VXML content 30. For example, if the selection definition file 25 in FIG. 8 is executed by the order receiving controller 21 in response to a request from the HTML browser 10, then the other browser that is to be synchronized with the HTML browser 10 is the VXML browser 11, and the combination of modals is “HTML” and “VXML,” so that the content creation file “merr_html.jsp” is selected for the HTML browser 10 and the content creation file “merr_vxml.jsp” is selected for the VXML browser 11, and the processing result is transferred to these content creation files. FIG. 9 shows the content of “merr_html.jps” and FIG. 10 shows the content of “merr_vxml.jps.” Moreover, the processing result data transferred to each of the content creation files may be given for example as a table in which content items are associated with results data, as shown in FIG. 7. Here, the created content for the different browsers is saved in files, but also possible is a configuration in which the content created for the browser that has originated the processing request is not saved but only transferred via the modal managing portion 24.

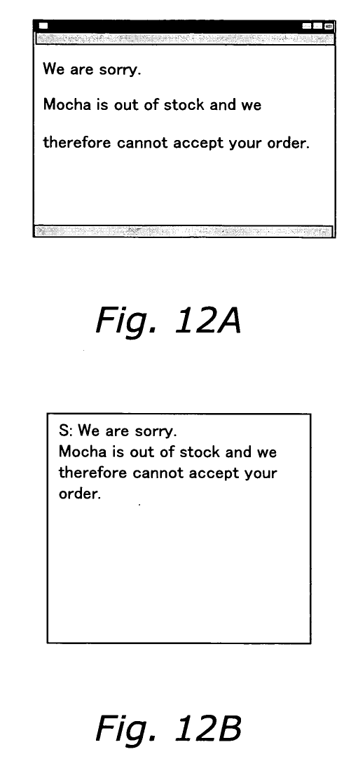

FIGS. 12A and 12B show examples of content in which the processing result data is reflected by the content creation files described above. FIG. 12A illustrates the content for the HTML browser when the processing result data has been reflected in the HTML content creation file 27 and FIG. 12B illustrates the utterance data for the VXML browser when the processing result data has been reflected in the VXML content creation file 28.

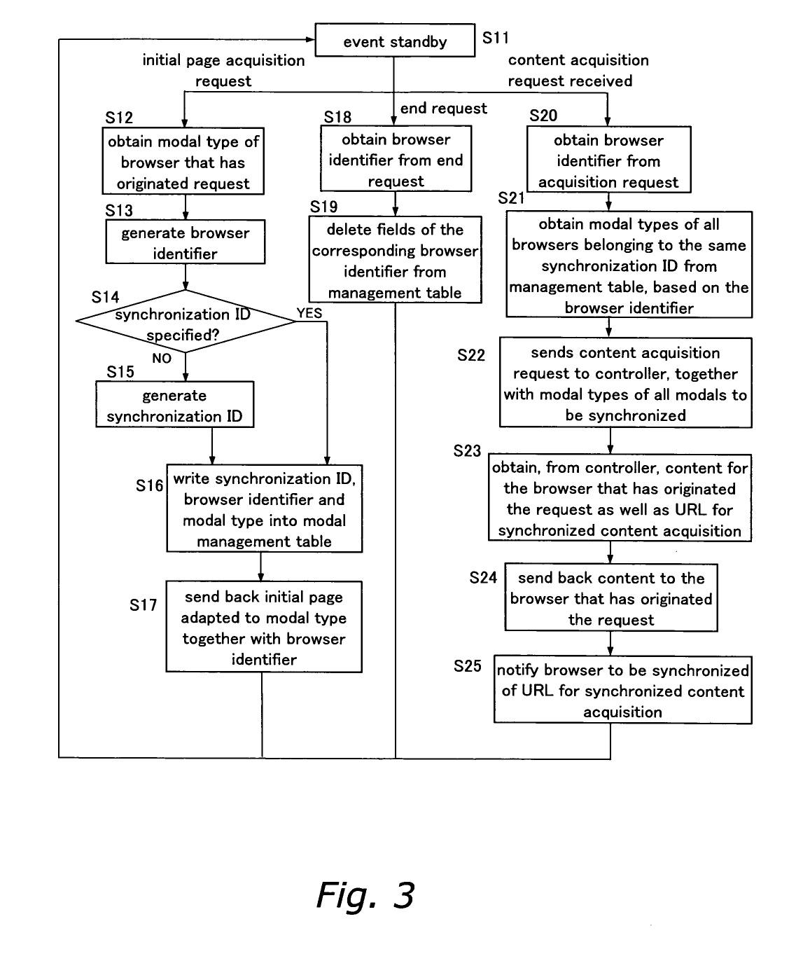

The following explains the operation of this first embodiment with flowcharts. FIG. 3 is a flowchart for the operation of the modal managing portion 24.

At Step S11, the server 20 is in an event standby state. If there is an initial page acquisition request from a browser, then the procedure advances to Step S12, if there is an end request, then the procedure advances to Step S18, and if there is a content acquisition request, then the procedure advances to Step S20.

At Step S12, the modal managing portion 24 discriminates the modal type included in the initial page acquisition request, thereby specifying the modal type of the browser originating the request. The determination of the modal type may be performed based on the HTTP header information sent by the browser at the time of the content request, for example.

At Step S13, the modal managing portion 24 generates a browser identifier for distinguishing the request from requests by other browsers.

At Step S14, the modal managing portion 24 determines whether there is a synchronization ID specified in the initial page acquisition request from the browser. If it is judged that no synchronization ID is specified, then the procedure advances to Step S15, and if it is judged that a synchronization ID is specified, then the procedure advances to Step S16.

At Step S15, the modal managing portion 24 generates a new synchronization ID for the browser originating the initial page acquisition request.

At Step S16, the synchronization ID, the browser identifier and the modal type are written into the modal management table managed by the modal managing portion 24. As noted above, the modal management table is configured as shown in FIG. 4, for example.

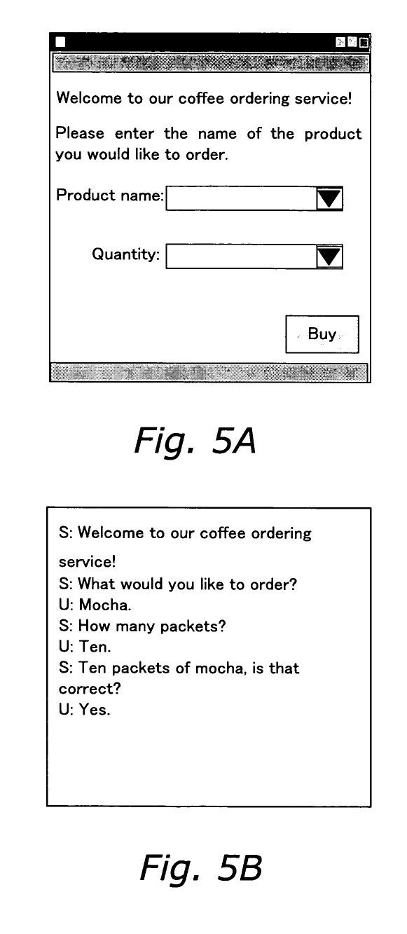

At Step S17, the modal managing portion 24 sends back the initial page corresponding to the modal type, together with the browser identifier. As the initial page, for example an initial screen for HTML browsers as shown in FIG. 5A and an initial dialogue for VXML browsers as shown in FIG. 5B are prepared and the modal managing portion 24 sends this content creation data to the browser that has originated the request. Moreover, the browser identifier that is sent together with the content creation data of the initial page is the one that was included in the processing request from the browser, and with this browser identifier, the modal managing portion 24 can detect the modal type of that browser and the other modals to be synchronized from the browser identifier.

Then, the procedure advances to Step S11.

At Step S18, the modal managing portion 24 obtains the browser identifier of the browser that has issued the end request.

At Step S19, the modal managing portion 24 deletes the corresponding fields of the browser identifier from the managed modal management table.

After that, the procedure advances to Step S11.

At Step S20, the modal managing portion 24 obtains the browser identifier of the browser that has issued the content acquisition request.

At Step S21, the modal managing portion 24 looks up the modal management table based on the obtained browser identifier, and obtains the modal type of the browser belonging to the same synchronization ID.

At Step S22, the modal managing portion 24 sends the content acquisition request to the order receiving controller 21, together with the modal types of all modals to be synchronized. The modal types can be sent using an HTTP header, for example.

At Step S23, the modal managing portion 24 obtains from the order receiving controller 21 the content for the browser that has originated the processing request as well as a URL for the synchronized content acquisition for the other browser, which is to be synchronized with the browser that has originated the processing request. The content for the browser that has originated the request is created from a content creation file extracted with the selection processing portion 26 and from processing result data of the ordering system 22. Moreover, the URL for the synchronized content acquisition indicates to the other browser, which is to be synchronized with the browser that has originated the processing request, the location at which the content created from the content creation file and the processing result data is stored.

At Step S24, the modal managing portion 24 sends the created content to the browser that has originated the processing request.

At Step S25, the modal managing portion 24 notifies the other browser, which is to be synchronized with the browser that has originated the processing request, of the URL for the synchronized content acquisition.

Then, the procedure advances to Step S11.

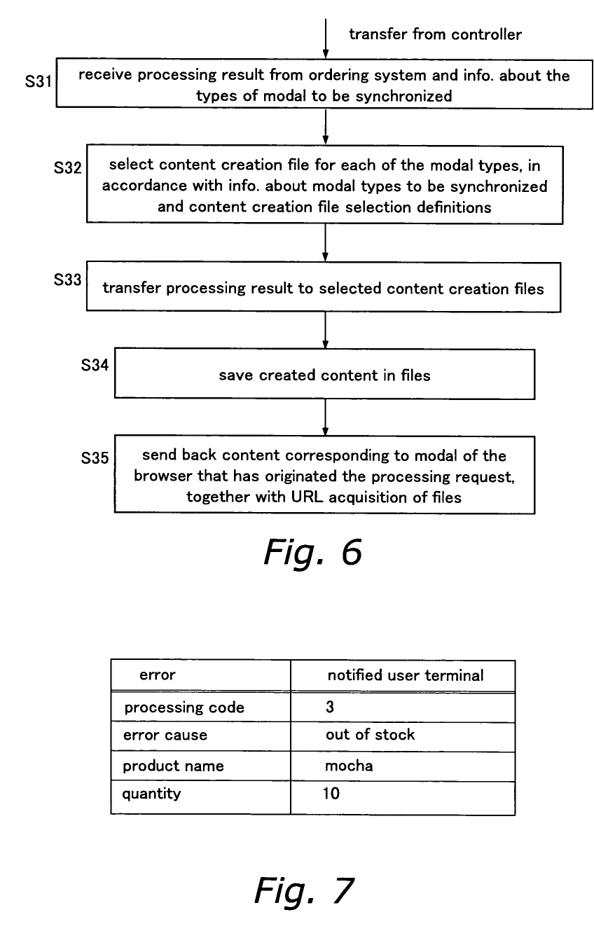

The operation of the selection processing portion 26 is explained with reference to the flowchart in FIG. 6.

At Step S31, the selection processing portion 26 receives the processing result and the information about the modal types to be synchronized from the ordering system 22 via the order receiving controller 21.

At Step S32, the selection processing portion 26 selects a content creation file for each of the modal types, in accordance with the information about the modal types to be synchronized and the selection definition information for the content creation files. As mentioned above, the selection processing portion 26 extracts the corresponding content creation files 27 and 28 from the selection definition information 25 as shown in FIG. 8.

At Step S33, the selection processing portion 26 transfers the processing result data of the ordering system 22 to the selected content creation files. For example, processing result data as shown in FIG. 7 are transferred to the HTML content creation file 27 shown in FIG. 9 and the VXML content creation file shown in FIG. 10, and as a result, content for each of the browsers that reflects the processing result of the ordering system 22 is created.

At Step S34, the selection processing portion 26 saves the created content in files. The content for the browser that has originated the processing request does not necessarily have to be saved and may also simply be sent as a response via the modal managing portion 24.

At Step S35, the selection processing portion 26 sends back the content created for the browser that has originated the processing request, and notifies the other browser to be synchronized of the URL for the synchronized content acquisition.

The operation of the content managing portion 31 is explained with reference to the flowchart in FIG. 11.

At Step S41, the content managing portion 31 is in an event standby state. If there is a content acquisition request from a browser, then the procedure advances to Step S42.

At Step S42, based on the content acquisition request from the browser, the content managing portion 31 reads the saved content and sends it back to the browser that has originated the request. In this case, it is a content acquisition request from the browser that has received the synchronized content acquisition notification, and the URL for the synchronized content acquisition as notified by the modal managing portion 24 is included in this acquisition request. Based on the URL for the synchronized content acquisition included in the acquisition request from the browser, the content managing portion 31 reads the synchronized content and sends it to the browser that has originated the request.

At Step S43, the content managing portion 31 deletes the content that has been requested by the browser and sent out.

### Second Embodiment

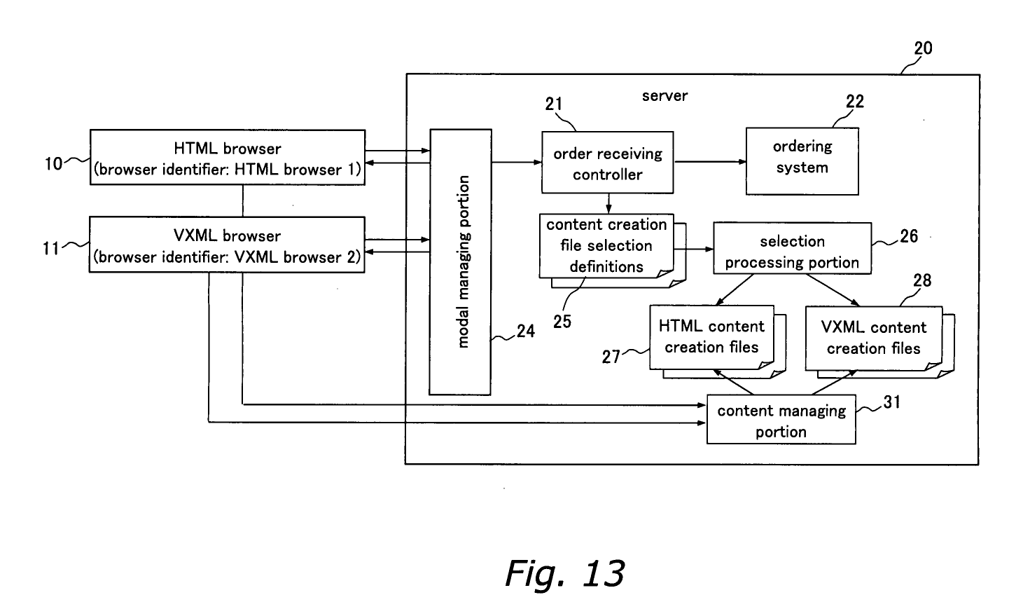

FIG. 13 shows the overall configuration of a multimodal interface system in accordance with a second embodiment of the present invention.

In the second embodiment, as in the first embodiment, the server 20 includes a modal managing portion 24, an order receiving controller 21, an ordering system 22, a selection processing portion 26, and a content managing portion 31. The modal managing portion 24 manages information relating to currently synchronized modals and browsers. The order receiving controller 21 receives input data from browsers via the modal managing portion 24. The ordering system 22 performs the actual order processing in response to requests from the order receiving controller 21. The selection processing portion 26 selects a content creation file based on selection definition files 25 for content creation files. The content managing portion 31 outputs content data in response to synchronized content acquisition requests from the browsers.

In the second embodiment, the content files are not created for each modal type in accordance with the content creation files 27 and 28 selected by the selection processing portion 26 as in the first embodiment, but only the data necessary for creating content is held in an internal memory, and content is created for each modal type as necessary.

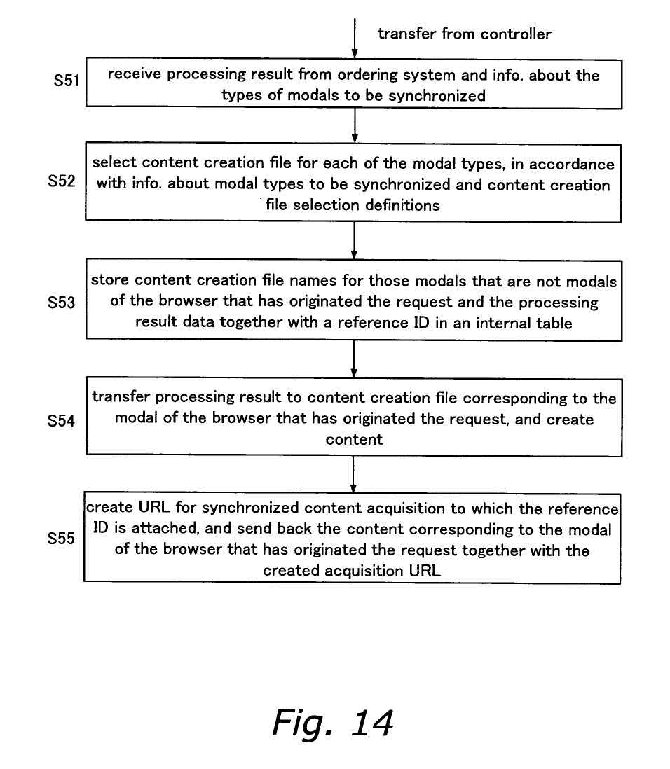

The operation of the modal managing portion 24 is similar to that of the first embodiment, so that further explanations thereof have been omitted. The operation of the selection processing portion 26 is explained with reference to the flowchart in FIG. 14.

At Step S51, the selection processing portion 26 receives the information about the modal types to be synchronized and the processing result from the ordering system 22 via the order receiving controller 21.

At Step S52, the selection processing portion 26 selects a content creation file for each of the modal types, in accordance with the information about the modal types to be synchronized and the selection definition information for the content creation files. As noted above, the selection processing portion 26 extracts the corresponding content creation files 27 and 28 from the selection definition information 25 as shown in FIG. 8.

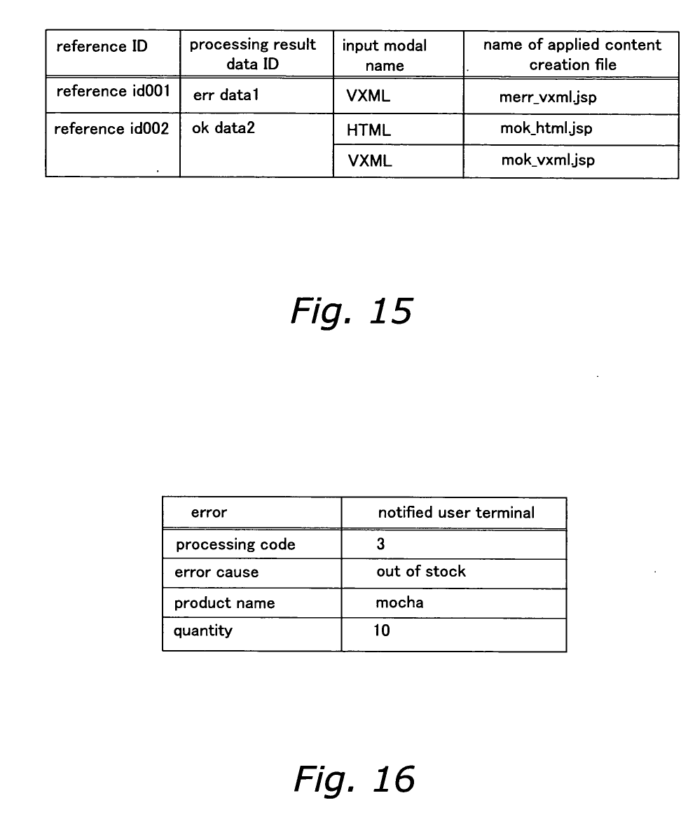

At Step S53, the selection processing portion 26 stores the content creation file names for those modals to be synchronized that are not modals of the browser that has originated the processing request and the processing result data of the ordering system 22 together with a reference ID in an internal table. As shown in FIG. 15, the internal table contains such items as reference ID, processing result data ID, input modal name and applied content creation file name, and is constituted by content data that is necessary for creating the content. The processing result data is the processing result data of the ordering system 22 in table form, and is constituted for example by data corresponding to the items as shown in FIG. 16, to which a processing result data ID (“err data 1” in the drawing) is appended.

At Step S54, the selection processing portion 26 transfers the processing result data of the ordering system 22 to the content creation file corresponding to the modal of the browser that has originated the processing request, and the content is created.

At Step S55, the selection processing portion 26 sends back the content created for the browser that has originated the processing request, creates a URL for the synchronized content acquisition to which the reference ID is attached, and notifies the browser to be synchronized of the URL for the synchronized content acquisition.

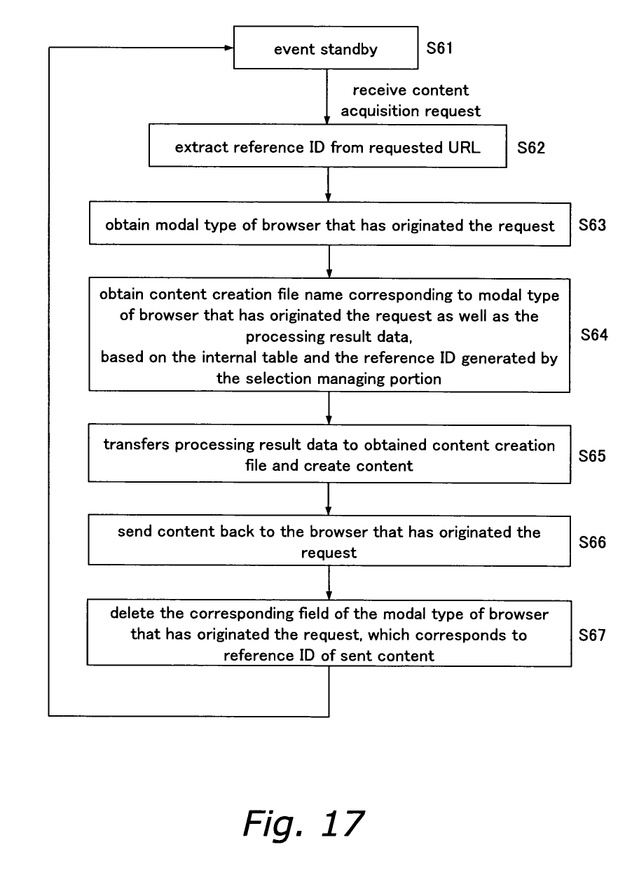

The operation of the content managing portion 31 is explained with reference to the flowchart in FIG. 17.

At Step S61, the content managing portion 31 is in an event standby state. If there is a content acquisition request from a browser, then the procedure advances to Step S62.

At Step S62, based on the content acquisition request from the browser, the content managing portion 31 extracts the reference ID. In this case, it is a content acquisition request from the browser that has received the synchronized content acquisition notification, and the URL for the synchronized content acquisition notified from the modal managing portion 24 is included in this acquisition request. The reference ID of the internal table created by the selection processing portion 26h is stored in this URL for the synchronized content acquisition, and the content managing portion 31 extracts this reference ID.

At Step S63, the content managing portion 31 obtains the modal type of the browser that has originated the acquisition request.

At Step S64, based on the internal table created by the selection processing portion 26 and the reference ID, the content managing portion 31 obtains the content creation file name corresponding to the modal type of the browser that has originated the request as well as the processing result data.

At Step S65, the content managing portion 31 transfers the processing result data to the obtained content creation file, and creates the content corresponding to the browser.

At Step S66, the content managing portion 31 sends the created content as the response to the browser that has originated the request.

At Step S67, the content managing portion 31 deletes the corresponding field of the modal type of the browser that has originated the request, which corresponds to the reference ID of the sent content.

For example, if a content request specifying “reference id001” is sent by a browser whose modal type is VXML to the content managing portion 31, then “merr_vxml.jsp” is extracted as the content creation file name to be applied from the internal table in FIG. 15 and “err data1” is extracted as the processing result data, the content of the processing result data “err data 1” is transferred to “merr_vxml.jsp” to create the content for the browser that has originated the request, and this created content is sent as the response to the browser that has originated the request.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A modal synchronization control method for a multimodal interface system comprising, for each modal, a browser that interprets content for a specified modal so as to interact with a user, performing data processing in response to a request from any of the browsers, creating content based on a processing result, and outputting the content to the browsers; the method comprising:
a step of preparing, in advance, selection definition information that is stored in association with a content creation file for each of the modal types to be applied, in accordance with a combination of a plurality of modals to be synchronized;
a step of looking up the selection definition information in response to a processing request from any of the browsers, and selecting for each modal a content creation file to be applied, from combinations of modals of the browser and another browser to be synchronized; and
a step of outputting content, which has been created by applying the selected content creation file, to the browser that has originated the processing request, and outputting content, which has been created by applying the corresponding content creation file of the selected content creation files, to the other browser that is to be synchronized with the browser.

2. The modal synchronization control method according to claim 1, further comprising:
a step of sending a content acquisition notification to the other browser to be synchronized; and
a step of outputting content in response to an acquisition request from the other browser to be synchronized.

3. A program for executing on a computer a modal synchronization control method for a multimodal interface system comprising, for each modal, a browser that interprets content for a specified modal so as to interact with a user, performing data processing in response to a request from any of the browsers, creating content based on a processing result, and outputting the content to the browsers; the method comprising:
a step of looking up, in response to a processing request from any of the browsers, the selection definition information stored in association with a content creation file for each of the modal types to be applied, in accordance with a combination of a plurality of modals to be synchronized and selecting for each modal a content creation file to be applied, from combinations of modals of the browser and another browser to be synchronized; and
a step of outputting content, which has been created by applying the selected content creation file, to the browser that has originated the processing request, and outputting content, which has been created by applying the corresponding content creation file of the selected content creation files, to the other browser that is to be synchronized with the browser.

4. A multimodal interface system comprising:
for each modal, a browser that interprets content for a specified modal so as to interact with a user, the multimodal interface system performing data processing in response to a processing request from any of the browsers, creating content based on a processing result, and outputting the content to the browsers;
a selection processing portion that looks up, in response to a processing request from any of the browsers, the selection definition information stored in association with a content creation file for each of the modal types to be applied, in accordance with a combination of a plurality of modals to be synchronized, and selects for each modal a content creation file to be applied, from combinations of modals of the browser and another browser to be synchronized; and
a content output portion that outputs content, which has been created by applying the selected content creation file, to the browser that has originated the processing request, and outputs content, which has been created by applying the corresponding content creation file of the selected content creation files, to the other browser that is to be synchronized with the browser.

5. The multimodal interface system according to claim 4, further comprising a modal managing portion, which manages combinations of a plurality of modals to be synchronized.

6. The multimodal interface system according to claim 5, wherein the modal managing portion receives a processing request from one of the browsers and sends content created by the content output portion to the browser that has originated the processing request.

7. A multimodal interface system comprising:
for each modal, a browser that interprets content for a specified modal so as to interact with a user, the multimodal interface system performing data processing in response to a request from any of the browsers, creating content based on a processing result, and outputting the content to the browsers;
a modal managing portion that manages combinations of a plurality of modals to be synchronized, and exchanges information with each of the modals;
a selection processing portion that looks up, in response to a processing request from a browser, the selection definition information stored in association with a content creation file for each of the modal types to be applied, in accordance with a combination of a plurality of modals to be synchronized, selects for each modal a content creation file to be applied, from combinations of a browser and another browser to be synchronized, creates content for the corresponding modal from the content creation file of each modal, outputs content created with the content creation files to the browser that has originated the processing request, and notifies the other browser to be synchronized of acquisition request information for acquiring content created with the content creation files via the modal managing portion; and
a content managing portion that, in response to acquisition request information that has been sent from the other browser to be synchronized, outputs content corresponding to that acquisition request information to that browser.

8. The multimodal interface system according to claim 7, wherein the content managing portion further has a function of deleting created content after outputting content corresponding to an acquisition request from the other browser to be synchronized to the browser that has originated the processing request.

9. A multimodal interface system comprising:
for each modal, a browser that interprets content for a specified modal so as to interact with a user, the multimodal interface system performing data processing in response to a processing request from any of the browsers, creating content based on a processing result, and outputting the content to the browsers;
a modal managing portion that manages combinations of a plurality of modals to be synchronized, and exchanges information with each of the modals;
a selection processing portion that looks up, in response to a processing request from a browser, the selection definition information stored in association with a content creation file for each of the modal types to be applied, in accordance with a combination of a plurality of modals to be synchronized, selects for each modal a content creation file to be applied, from combinations of a browser and another browser to be synchronized, outputs content created with a content creation file for the browser that has originated the processing request, stores information identifying the content creation file selected for the other browser to be synchronized in association with information related to a processing result of a process executed in response to a processing request from the browser, and notifies the other browser to be synchronized of acquisition request information for acquiring content via the modal managing portion; and
a content managing portion that, in response to acquisition request information that has been sent from the other browser to be synchronized, creates content from a content creation file corresponding to that acquisition request information and information relating to the processing result, and outputs the created content to that browser.
